(19) United States
(12) Patent Application Publication
(10) Pub. No.: US 2014/0168236 A1
(43) Pub. Date: Jun. 19, 2014

(54) GPU DISPLAY ADJUSTMENTS

(71) Applicant: QNX SOFTWARE SYSTEMS LIMITED, Kanata (CA)

(72) Inventors: Thomas Derrick Keefe, Ottawa (CA); Etienne Belanger, Kanata (CA)

(73) Assignee: QNX SOFTWARE SYSTEMS LIMITED, Kanata (CA)

(21) Appl. No.: 13/719,411

(22) Filed: Dec. 19, 2012

(51) Int. Cl. G09G 3/34

(52) U.S. Cl. CPC G09G 3/3406
USPC 345/520; 345/690

(57) ABSTRACT

A system makes application image specific brightness and/or contrast adjustments. The system may include a light controller and an application that controls an application image. The light controller may receive a light adjustment request from the application or a different application. The light adjustment request may be a request for an adjustment that is specific to an application image in a display area. The light controller may set the brightness and/or the contrast of the application image differently than a portion of the display area that excludes the application image. The light controller may set the brightness and/or the contrast of the application image based on the light adjustment request.

### BACKGROUND

1. Technical Field

This application relates to display adjustments and, in particular, to light intensity adjustments.

2. Related Art

A typical display system, such as a television, a computer monitor, a portable phone, or any other device that includes a display, may include a mechanism for adjusting a brightness setting and/or a contrast setting that applies to whatever is displayed on the display. Because these adjustments apply to the entire display area, the adjustments may be performed in the last processing step before displaying the image. The adjustments may be made with analog electronics or digital signal processing.

Some display systems may incorporate a backlight whose overall output level may be adjusted. The amount of light generated by the backlight may be adjusted in order to reduce power consumption and/or to increase readability as ambient light levels vary. An external light sensor may sense an ambient light level from which a suitable back light level may be determined. The backlight level applies to the overall display area.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates a system for making application image specific brightness and/or contrast adjustments; and

FIG. 2 illustrates a flow diagram of the logic of the system for making application image specific brightness and/or contrast adjustments.

### DETAILED DESCRIPTION

When changing the brightness of an image, a constant may be added to, or subtracted from, the luminance of all luminance values in the image. Changing the brightness may be equivalent to shifting the contents of a histogram of the image to the left (subtraction) or to the right (addition).

On the other hand, when changing the contrast of an image, the range of luminance values present in the image may be altered. Visualized in a histogram of the image, changing the contrast may be equivalent to expanding or compressing the histogram around a midpoint of the histogram.

Brightness or contrast adjustments to the overall image may result in undesirable effect under certain conditions. Many computing systems display images that are a composition of a number of different applications. For example, the composited image may be a composition of a background image overlaid with several application images that each take up less space than the full display area. When global adjustments are made to the composited image, such as changes in brightness, contrast, and backlight level, the adjustments may make some application images appear too bright while others appear too dark.

In one example, a system is provided to make application image specific brightness and/or contrast adjustments. The system may include a light controller and an application. The light controller may be implemented in software, such as a component of an operating system, or be implemented in hardware, such as a 3D graphics engine or a graphics accelerator. The light controller may receive a light adjustment request from the application, where the light adjustment request is a request for an adjustment specific to an application image in a display area. The content of the application image is controlled by the application. Based on the light adjustment request received from the application, the light controller may set the brightness and/or the contrast of the application image differently than a portion of the display area that excludes the application image.

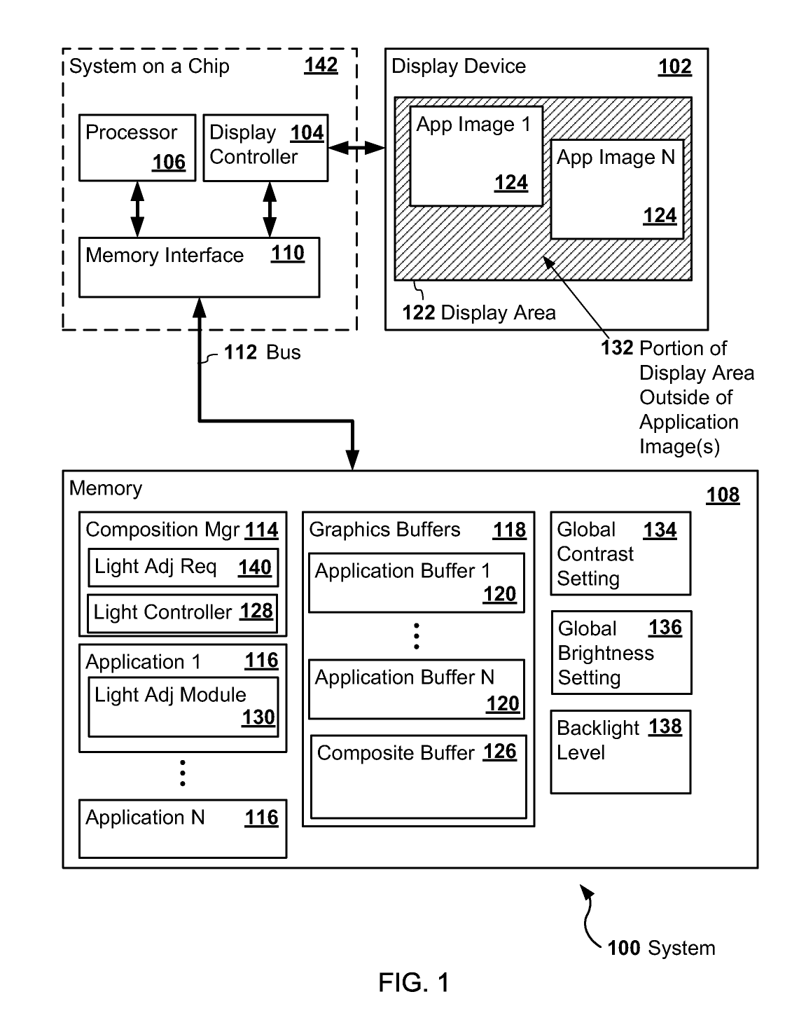

FIG. 1 illustrates a system 100 for making application image specific brightness and/or contrast adjustments. The system 100 may include a display device 102, a display controller 104, a processor 106, and a memory 108. The system 100 may also include a memory interface 110 and a bus 112.

The display device 102 may be any electro-optical device for displaying data. In particular, the display device 102 may display the data in a display area 122. Examples of the display device 102 may include a light emitting diode display (LED), a liquid crystal display (LCD), a cathode ray tube (CRT), an electro-luminescent display, a plasma display panel (PDP), a vacuum florescent display (VFD), or any other display device. The display device 102 may be an internal or external display.

The display controller 104 may be any hardware that reads an image from the memory 108 and causes the image to be displayed in the display device 102. Examples of the display controller 104 may include a controller that drives an LCD (liquid crystal display) panel with a VGA (video graphics array) format, a controller that drives a LCD and/or a LED panel at a resolution of 2048×1152, and a controller that drives a HDMI® (High-Definition Multimedia Interface) or DVI (Digital Visual Interface) port (HDMI is a registered trademark of HDMI Licensing L.L.C. CORPORATION of Sunnyvale, Calif.).

The processor 106 may be any component that includes hardware and/or a combination of hardware and software that performs logic and accesses memory. The memory may include the memory 108 illustrated in FIG. 1 or any other memory. The processor 106 may include a central processing unit (CPU), a two dimensional (2D) engine, a graphics processing unit (GPU), a general processor, a multi-core processor, an application specific integrated circuit (ASIC), a digital signal processor, a field programmable gate array (FPGA), a digital circuit, an analog circuit, a microcontroller, any other type of processor.

The memory 108 may be any device for storing and retrieving data or any combination thereof. The memory 108 may include non-volatile and/or volatile memory, such as a random access memory (RAM), a read-only memory (ROM), an erasable programmable read-only memory (EPROM), or a flash memory. Alternatively or in addition, the memory 108 may include an optical, magnetic (hard-drive) or any other form of data storage device.

The memory interface 110 may be any component that manages the transportation of data going to and from the memory 108, such as between the processor 106 and the memory 108. The memory interface 110 may include any memory controller, such as a Memory Chip Controller (MCC), a Double Data Rate2 (DDR2) memory controller used to drive DDR2 SDRAM (double data rate synchronous dynamic random-access memory), a Peripheral Component Interconnect (PCI) bus controller, or any other type of memory controller. The memory interface 110 may communicate with the memory 108 over the bus 112.

The bus 112 may be any hardware that transfers data. Examples of the bus 112 may include a 64 bit DDR2 bus operating at 400 Megahertz or any other type of bus.

The memory 108 may store computer code, such as a composition manager 114 or applications 116 (individually designated Application 1 through Application N in FIG. 1). The computer code may include instructions executable with the processor 106. The computer code may be written in any computer language, such as C, C++, Java, assembly language, shader code, channel program code, and/or any combination of computer languages.

The memory 108 may include graphics buffers 118. The graphics buffers 118 may include individual application buffers 120, which are individually designated Application Buffer 1 through Application Buffer N in FIG. 1. Each of the application buffers 120 may represent a corresponding application image that may be drawn by a corresponding one of the applications 116. For example, the application buffers 120 may correspond to application images 124, individually designated Application Image 1 through Application Image N in FIG. 1. In other words, Application Buffer 1 through Application Buffer N may represent Application Image 1 through Application Image N, respectively.

The graphics buffers 118 may include a composite buffer 126. The composite buffer 126 may represent a composite image that is a composition of the application images 124. The composite image may, for example, comprise a background image overlaid with the application images 124, where each of the application images 124 takes up less than the full display area 122.

The composition manager 114 may be any component that composites or directs the composition of the individual application images 124 into the composite image. In some examples, the composition manager 114 may refer to a graphics system, a window manager, or a component thereof. The application images 124 may include windows generated and/or controlled in part by a windows based operating system, such an operating system for a mobile electronic device, a desktop computer, or a server. Examples of the windows based operating system may include MICROSOFT WINDOWS®, which is a registered trademark of Microsoft Corporation of Redmond, Wash.; LINUX®, which is a registered trademark of Linus Torvalds of Finland; and ANDROID™, which is a trademark of Google, Inc. of Mountain View, Calif. Alternatively or in addition, any of the application images 124 may include a task bar, a background picture, a frame in a sequence of frames of a video, or any other type of digital image.

The composition manager 114 may include a light controller 128. The light controller 128 may be any component that adjusts the contrast and/or the brightness of one or more of the application images 124 on behalf of one or more of the applications 116. The composition manager 114 may, in some examples, also adjust the contrast and/or the brightness of the overall display area 122.

One or more of the applications 116 may include a light adjustment module 130. The light adjustment module 130 of the application 116, such as Application 1 in FIG. 1, may be any component that determines whether the contrast and/or the brightness of one or more of the application images 124 owned by the application 116 is to be different than a portion 132 of the display area 122 outside of the one or more application images 124 owned by the application 116. The application image 124 may be owned by the application 116 if the application image 124 is drawn by the application 116 or the content of the application image 124 is controlled by the application 116. For example, Application 1 may own Application Image 1 but not own any other of the application images 124. In such an example, the portion 132 outside of Application Image 1 may include all of the display area 122, including Application Image N, but exclude Application Image 1.

During operation of the system 100, global light adjustments may be applied to the composite image and/or the display area 122. The global light adjustments may include, for example, an application of a global light setting. The global light setting may be any setting related to light levels applicable to the entire display area 122. Examples of the global light setting may include a global contrast setting 134, a global brightness setting 136, and/or a backlight level 138. The global contrast setting 134 may be a setting that identifies what contrast applies to the display area 122. The global brightness setting 136 may be a setting that identifies what brightness applies to the display area. The backlight level 138 may indicate an amount of light provided as backlight to the display area 122.

The system 100 may compensate for the global image adjustments by making application image specific adjustments. As explained further below, each application 116 may make application image specific adjustments in coordination with the global light adjustments.

The light adjustment module 130 of the application 116 may determine whether the application image 124 owned by the application 116 is to have a different contrast and/or brightness setting than the portion 132 of the display area 122 outside of the application image 124. The light adjustment module 130 may determine that the application image 124 is to have a different contrast and/or brightness setting than other portions 132 of the display area 122 for any number of reasons.

In one example, the light adjustment module 130 may make such a determination based on a difference between the application image 124 owned by the application 116 and the application image 124 owned by one or more of the other applications 116. When the global light adjustments are applied to the composite image, such adjustments may make a first subset of the application images 124 appear too bright and a second subset of the application images 124 appear too dark because a color palette used for the first subset of the application images 124 may differ from a color palette used for the second subset of the application images 124. For example, Application 1 may be a navigation application and Application N may be a web browser. Application Image 1, owned by the navigation application, may include substantially more white space than Application Image N, owned by the web browser. Accordingly, an average brightness of Application Image 1 may be substantially higher than an average brightness of Application Image N. The navigation application, Application 1, may determine that the brightness of Application Image 1 is to be decreased because the average brightness of Application Image 1 is higher and/or substantially higher than the average brightness of Application Image N.

In a second example, the light adjustment module 130 of the application 116 may determine, based on the global light setting, that the application image 124 owned by the application is to have a different contrast and/or brightness setting than the portion 132 of the display area 122 outside of the application image 124. For example, the light adjustment module 130 may determine that the brightness and/or the contrast of the application image 124 is to be adjusted so that the application image 124 remains visible based on the backlight level 138, the global brightness setting 136, the global contrast setting 134, a light intensity histogram of the application image 124, and/or an amount of light detected by a light sensor that detects ambient light around the display area 122. Application 1 may be a video game, for example. The video game may use a relatively dark palette compared with other types of applications. If the video game is played in a dark room, then the backlight level 138 may be higher in order to compensate for the dark room. The light adjustment module 130 may determine that because the backlight level 138 is over a threshold level, for example, the brightness setting of Application Image 1 is to increase so that Application Image 1 remains visible in the dark room. Alternatively, a light sensor may provide a light level that ranges from zero to 100, where zero indicates no ambient light is detected, and 100 indicates a maximum detectable amount of ambient light is detected. The light adjustment module 130 may determine that the room is dark when the light level is less than a threshold amount, such as 20. In some examples, a relative brightness of the application image 124 may be determined by the light adjustment module 130 based on the backlight level 138, the global brightness setting 136, the global contrast setting 134, the light intensity histogram of the application image 124, and/or the amount of light detected by the light sensor. If the relative brightness exceeds a threshold level, then the light adjustment module 130 of the application 116 may determine that the brightness of the application image 124 owned by the application 116 is to decrease. Conversely, if the relative brightness is below the threshold level, then the light adjustment module 130 may determine that the brightness of the application image 124 is to increase.

In a third example, the light adjustment module 130 of the application 116 may determine, based on a status of the application 116, that the application image 124 owned by the application 116 is to have a different contrast and/or brightness setting than the portion 132 of the display area 122 outside of the application image 124. The status of the application 116 may include whether the application 114 is in-focus (currently active or in foreground), whether the application 114 is displaying an error condition, whether the application 114 is attempting to obtain the attention of a user, or any other state of the application 114. For example, if the application image 124 owned by the application 114 is in-focus, then the light adjustment module 130 may determine that the brightness and/or the contrast of the application image 124 may be increased or decreased. If Application 1 is the video game, for example, then the light adjustment module 130 of Application 1 may determine that the brightness setting of Application Image 1 is to increase if the backlight level 138 is over the threshold level and Application 1 is in-focus, but not if Application 1 is not in-focus.

In a fourth example, the light adjustment module 130 of the application 116 may determine, based on an analysis of the application image 124 owned by the application 116, that the application image 124 is to have a different contrast and/or brightness setting than the portion 132 of the display area 122 outside of the application image 124. For example, the light adjustment module 130 may generate a histogram of the palette of the application image 124. The light adjustment module 130 may determine that an equalization of the palette is to be made in order to obtain a target histogram. For example, if more than 90 percent of the values in the histogram are below half of the brightness range, then the light adjustment module 130 may determine that the values in the histogram are to be increased such that more than 90 percent of the values are at least half of the brightness range. The light adjustment module 130 may perform the analysis of the application image 124 in real-time, repeatedly analyzing the application image 124 and determining whether the brightness and/or the contrast of the application image 124 is to increase, decrease, or stay the same.

If the light adjustment module 130 determines that the application image 124 is to have a different contrast and/or brightness setting, then the light adjustment module 130 of the application 116 may transmit a light adjustment request 140 to the light controller 128. The light adjustment request 140 may be a request to adjust the brightness and/or the contrast of one or more of the application images 124. The light controller 128 may receive the light adjustment request 140 from the application 116. The light adjustment request 140 may be applicable only to one or more of the application images 124 in the display area 122 instead being applicable to the entire display area 122.

The light adjustment request 140 may include an indication of which of the application images 124 the request is for. Alternatively or in addition, the light adjustment request 140 may include an indication of how the light controller 128 is to adjust the application image 124. For example, the light adjustment request 140 may include a brightness setting and/or a contrast setting. The brightness setting and/or the contrast setting may be relative to the global brightness setting 136 and/or the global contrast stetting 134, respectively. Alternatively, the brightness setting and/or the contrast setting included in the light adjustment request 140 may not be relative to the global brightness setting 136 and/or the global contrast stetting 134, respectively. Each of the brightness and/or the contrast settings may be a numeric value, a percentage value, a range of values, a structure that describes how the histogram of the application image 124 is to be adjusted, or any other suitable data type.

The application 116 may transmit the light adjustment request 140 to the light controller 128 by invoking a programmatic function call, an inter-process call, a remote procedure call, or any other mechanism for passing information. In response to receipt of the light adjustment request 140, the light controller 128 may fulfill the light adjustment request 140.

For example, if the light adjustment request 140 includes a request to change the brightness of Application Image 1, then the light controller 128 may adjust the brightness in corresponding Application Buffer 1. Alternatively or in addition, if the light adjustment request 140 includes a request to change the contrast of Application Image 1, then the light controller 128 may adjust the contrast in corresponding Application Buffer 1.

The light controller 128 of the composition manager 114 may receive one or more of the light adjustment requests 140 from any number of the applications 116. The light controller 128 may perform the requested image adjustments to each of the application buffers 120 to which the light adjustment requests 140 apply. Alternatively, the light controller 128 may perform the requested image adjustments on a different buffer. For example, the light controller 128 may perform the requested image adjustments to a subset of the composite buffer 126 that represents the application image 124 or a portion thereof.

Each of the application images 124 may be generated by the application 116 as a sequence of frames. Each of the frames may be an image in a sequence of images ordered in time. Each of the frames may be represented or stored in one or more of the graphics buffers 118. The light controller 128 may perform the requested image adjustments to each new frame of the application image 124. The application 116 may draw or otherwise control the content of each frame of the application image 124. After the application 116 completes a frame of the application image 124, the light controller 128 may perform the requested image adjustments to the frame. After the application 116 completes the next frame in the series of frames, the light controller 128 may perform the requested image adjustment to the next frame, and so on.

Upon receipt of a second light adjustment request 140 that is specific to the application image 124, the light controller 128 may begin performing the requested image adjustment requested in the second light adjustment request 140 instead of the image adjustment requested in the first light adjustment request 140. The light controller 128 may receive a request from the light adjustment module 130 to stop performing image adjustments to the application image 124 if, for example, the light adjustment module 130 determines that the application image 124 does not need light adjustments.

Performing image adjustments to each of the applicable application buffers 120 may consume a substantial amount of processing power. However, the processor 106 may include a GPU (graphics processing unit) that performs the application image specific adjustments during a rendering stage, thereby lowering the overall computational cost of performing the application image specific adjustments.

GPUs may support standards like OPENGL® ES 2.0 (OPENGL is a registered trademark of Silicon Graphics, Inc. of Mountain View, Calif.). OPENGL® ES 2.0 is a cross-platform API for full-function 2D and 3D graphics on embedded systems—including consoles, phones, mobile devices, appliances and vehicles. The standard includes subsets of desktop OpenGL, creating a flexible and powerful low-level interface between software and graphics acceleration. Such standards permit shading programs (shaders), which are executed by the GPU, to be modified during run-time.

A shader may include executable instructions that when executed, calculate rendering effects using graphics hardware. Shaders may be used to program a GPU programmable rendering pipeline. Shaders may facilitate the creation of customized effects.

The above-described application image specific adjustments may be performed with shading programs executed on the GPU. Because application images 124 may be completely rendered with the GPU—including a Graphical User Interface—the application image specific adjustments may be performed during the rendering stage with much lower computational overhead than may be required in other configurations. Alternatively or in addition, the processor 106 may include a Central Processing Unit (CPU) that performs the application image specific adjustments.

The application 116 may receive the global light setting from an operating system and/or a shader program. The light adjustment module 130 of the application 116 may direct the operating system and/or the shader program to adjust the brightness and/or the contrast of the application image 124 relative to the received global light setting.

In some examples, the application 116 may own two or more of the application images 124. The light adjustment controller 128 of the application 116 may control the brightness and/or the contrast of the application images 124 owned by the application 116 individually. Alternatively, the light adjustment controller 128 of the application 116 may control the brightness and/or the contrast of the application images 124 as a group.

In some examples, the light adjustment module 130 may be included in a first one of the applications 116 and may control the brightness and/or the contrast of one of the application images 124 owned by a second one of the applications 116. The first one of the applications 116 may be a component, such as the composition manager 114, or any other type of software and/or hardware. For example, a system controller may emphasize a selected application window over non-selected application windows by making light adjustments to the selected application window and/or the non-selected application windows. In one example, the system controller may increase the brightness of the selected application window to emphasize the selected application window. In a second example, the system controller may decrease the brightness of the non-selected application windows to emphasize the selected application window. To cause the light adjustment to be made, the first one of the applications 116 may transmit the light adjustment request 140 to the light controller 128 by invoking a programmatic function call, an inter-process call, a remote procedure call, or any other mechanism for passing information.

The system 100 may be implemented in many different ways. For example, although some components may be shown stored in the memory 108 (for example, as logic implemented as computer-executable instructions or as data structures in memory), such logic and/or data structures may be stored on, distributed across, or read from other machine-readable storage media. The computer-readable storage media may include memories, hard disks, floppy disks, CD-ROMs, or any other type of memory from which a processor may read data. Alternatively or in addition, components that are shown stored in the memory 108, such as the composition manager 114 and the light controller 128, may be implemented in hardware instead of being stored in the memory 108.

The system 100 may be implemented with additional, different, or fewer components than is illustrated in FIG. 1. For example, the system 100 may not include the composition manager 114. In some examples, the system 100 may not include the display device 102. In one example, the system 100 may include only the light controller 128 that communicates with the applications 116. The system 100 may be included in any computing device, such as mobile computing device, a laptop, a smart phone, a Personal Digital Assistant, a desktop computer, a tablet computer, an appliance, or an embedded system. The display device 102 may be external to the system 100 or integrated into the computing device.

Furthermore, each one of the components of the system 100 may include more, fewer, or different elements than is illustrated in FIG. 1. For example, the memory 108 may include more, fewer, or different modules, graphics buffers, and applications. Moreover, the various modules are but one example of such functionality and any other configurations of modules encompassing similar functionality are possible. The light controller 128, for example, may be included in a different component than the composition manager 114. Instead, the light controller 128 may be included in the display controller 104 or some other component. In another example, one or more of the features of the light controller 128 may be implemented in a different module.

In some examples, one or more of the components of the system 100 may be included in a System on a Chip (SOC) 142. For example, the SOC 142 may include the processor 106, the memory interface 110 and the display controller 104. In another example, the SOC 142 may include fewer, different, or additional components. For example, the processor 106 may include multiple processors, such as a GPU and a CPU.

The components of the system 100 may be resident on separate hardware, such as separate removable circuit boards, or share common hardware, such as a same memory and processor for implementing instructions from the memory. Programs may be parts of a single program, separate programs, or distributed across several memories and processors.

The processing capability of the system 100 may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library or a shared library such as a dynamic link library (DLL). The DLL, for example, may store code that implements all or part of the light adjustment module 130.

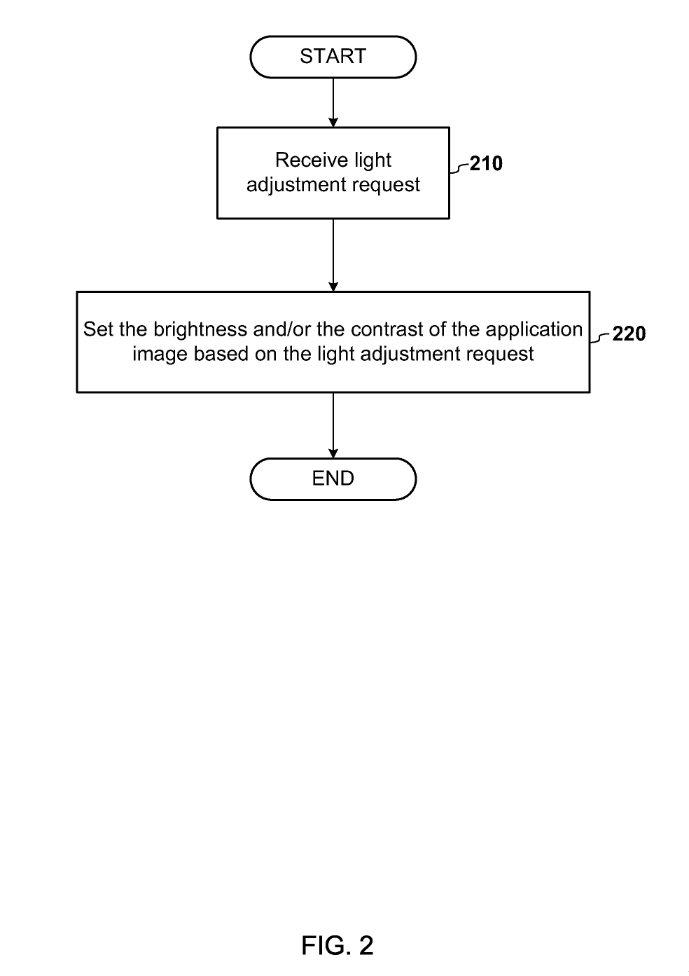

FIG. 2 illustrates a flow diagram of the logic of the system 100 for making application image specific brightness and/or contrast adjustments. Operations may begin with an operation in which the light adjustment request 140 is received with the processor 106 (210). The light adjustment request 140 may be specific to the application image 124 in the display area 122, where the application image 124 is owned by the application 116.

The brightness and/or the contrast of the application image 124 may be set, but not the portion 132 of the display area 122 that is outside of the application image 124, according to the light adjustment request 140 (220). The brightness and/or the contrast of the application image 124 may be set according to the light adjustment request 140 on each frame of the application image 124 generated by the application 116.

The operations may end by, for example, causing the application image 124 to display on the display device 102. The logic may include additional, different, or fewer operations than illustrated in FIG. 2. For example, the operations may begin with an operation in which the application 116 determines that the brightness and/or the contrast of the application image 124 is to be different than the portion 132 of the display area 122 that is outside of the application image 124. The application 116 may then transmit the light adjustment request 140 to the light controller 128.

All of the discussion, regardless of the particular implementation described, is exemplary in nature, rather than limiting. For example, although selected aspects, features, or components of the implementations are depicted as being stored in memories, all or part of systems and methods consistent with the innovations may be stored on, distributed across, or read from other computer-readable storage media, for example, secondary storage devices such as hard disks, floppy disks, and CD-ROMs; or other forms of ROM or RAM either currently known or later developed. The computer-readable storage media may be non-transitory computer-readable media, which may include CD-ROMs, volatile or non-volatile memory such as ROM and RAM, or any other suitable storage device. Moreover, the various modules and screen display functionality is but one example of such functionality and any other configurations encompassing similar functionality are possible.

Furthermore, although specific components of innovations were described, methods, systems, and articles of manufacture consistent with the innovations may include additional or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same program. The components may be resident on separate hardware, such as separate removable circuit boards, or share common hardware, such as a same memory and processor for implementing instructions from the memory. Programs may be parts of a single program, separate programs, or distributed across several memories and processors.

The respective logic, software or instructions for implementing the processes, methods and/or techniques discussed above may be provided on computer-readable media or memories or other tangible media, such as a cache, buffer, RAM, removable media, hard drive, other computer readable storage media, or any other tangible media or any combination thereof. The tangible media include various types of volatile and nonvolatile storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the logic or instructions are stored in a remote location for transfer through a computer network or over telephone lines. In yet other embodiments, the logic or instructions are stored within a given computer, central processing unit (“CPU”), graphics processing unit (“GPU”), or system.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments of the innovation have been described, it will be apparent to those of ordinary skill in the art that many more embodiments and implementations are possible within the scope of the innovation. Accordingly, the innovation is not to be restricted except in light of the attached claims and their equivalents.

What is claimed is:

1. A system to make application image specific brightness and/or contrast adjustments, the system comprising:
a display device comprising a display area;
a memory comprising a light controller and an application; and
a processor, wherein:
the light controller is executable with the processor to receive a light adjustment request that is specific to an application image in the display area, wherein content of the application image is controlled by the application; and
the light controller is executable with the processor to set a brightness and/or a contrast of the application image differently than a portion of the display area excluding the application image, wherein the brightness and/or the contrast of the application image is set based on the light adjustment request, and is applied to a series of frames of the application image over time.

2. The system of claim 1, wherein the processor comprises a graphics processing unit, and wherein the light controller comprises a shader program executable with the graphics processing unit to set the brightness and/or the contrast of the application image.

3. The system of claim 1 wherein the application transmits the light adjustment request to the light controller.

4. The system of claim 1, wherein the memory comprises a light adjustment module executable to determine that the application image is to have the contrast and/or the brightness that is different than the portion of the display area excluding the application image.

5. The system of claim 4, wherein the application image is a first application image, and the application is a first application, wherein the portion of the display area excluding the first application image comprises a second application image controlled by a second application, wherein the light adjustment module is executable to determine, based on a difference between the first application image and the second application image, that the first application image is to have the contrast and/or the brightness that is different than the portion of the display area excluding the first application image.

6. The system of claim 4, wherein the light adjustment module is executable to determine, based on a global light setting, that the application image is to have the contrast and/or the brightness that is different than the portion of the display area excluding the application image, and wherein the global light settings is a setting applicable to all of the display area.

7. The system of claim 4, wherein the light adjustment module is executable to determine, based on a status of the application, that the application image is to have the contrast and/or the brightness that is different than the portion of the display area excluding the application image.

8. A computer-readable storage medium encoded with computer executable instructions, the computer executable instructions executable with a processor, the computer-readable storage medium comprising:
instructions executable to receive a light adjustment request for an application image in a display area, wherein the application image is drawn by the application; and
instructions executable to set a brightness and/or a contrast of the application image differently than a portion of the display area that excludes the application image, wherein the brightness and/or the contrast of the application image is set on a series of frames of the application image over time according to the light adjustment request.

9. The computer-readable storage medium of claim 8, wherein the instructions executable to set the brightness and/or the contrast of the application image comprise a shader program.

10. The computer-readable storage medium of claim 8 further comprising instructions executable to determine that the brightness and/or the contrast of the application image is to be set differently than the portion of the display area that excludes the application image based on a determination that a color palette of the application image differs from a color palette used in the portion of the display area that excludes the application image.

11. The computer-readable storage medium of claim 8 further comprising instructions executable to determine that the brightness and/or the contrast of the application image is to be set differently than the portion of the display area that excludes the application image based on a determination that that the brightness of the application image is to be increased because an average brightness of the application image is lower than an average brightness of another application image in the display area.

12. The computer-readable storage medium of claim 8 further comprising instructions executable to determine a relative brightness of the application image based on a global light setting.

13. The computer-readable storage medium of claim 12 further comprising instructions executable to transmit the light adjustment request from the application in response to a determination that the relative brightness of the application image is below a threshold.

14. The computer-readable storage medium of claim 13, wherein the global light setting comprises a backlight level.

15. A computer-implemented method for making application image specific brightness and/or contrast adjustments, the method comprising:
receiving a light adjustment request with a processor, wherein the light adjustment request is specific to an application image in a display area, and wherein the application image is owned by the application; and
setting, with the processor, a brightness and/or a contrast of the application image, but not a portion of the display area that is outside of the application image, according to the light adjustment request, wherein the brightness and/or the contrast of the application image is set on each of a plurality of frames of the application image generated by the application.

16. The method of claim 15 further comprising providing the application with a global backlight level from which the application bases the light adjustment request.

17. The method of claim 16, further comprising determining the light adjustment request based on the global backlight level.

18. The method of claim 15 further comprising providing the application with a global light setting and determining the light adjustment request with the application based on the global light setting.

19. The method of claim 15 wherein adjusting the brightness and/or the contrast of the application image according to the light adjustment request comprises adjusting the brightness and/or the contrast of the application image with a graphics processing unit.

20. The method of claim 15 further comprising receiving, from each of a plurality of applications, a respective light adjustment request made based on a global light adjustment.
